(19) United States
(12) Patent Application Publication
(10) Pub. No.: US 2024/0055883 A1
(43) Pub. Date: Feb. 15, 2024

(54) CONVERTER FOR A RECHARGEABLE BATTERY

(71) Applicant: Coast Cutlery Co., Portland, OR (US)

(72) Inventors: Todd Ernst, Portland, OR (US); Aking Peng, Shenzhen (CN); Daniel Sechler, Portland, OR (US); Kunli Wang, Shenzhen (CN); Rory Pynenburg, Portland, OR (US)

(21) Appl. No.: 17/885,502

(22) Filed: Aug. 10, 2022

(51) Int. Cl. H02J 7/00; H01M 10/44

(52) U.S. Cl. CPC H02J 7/00714; H02J 7/00711; H02J 7/0063; H01M 10/44; H02J 2207/20

(57) ABSTRACT

A converter for a rechargeable battery (e.g., lithium battery) is disclosed. In some embodiments, the converter includes a direct current (DC) to DC converter and a microcontroller unit (MCU). The DC to DC converter includes a switching circuit configured to generate a pulse width modulated (PWM) voltage from the rechargeable battery voltage, wherein the switching circuit is configured to set a variable duty cycle of the PWM voltage. The DC to DC converter also includes a filtering circuit configured to convert the PWM voltage into a DC output voltage having an output voltage level that is set in accordance with the variable duty cycle of the PWM voltage. The MCU is configured to adjust the variable duty cycle of the switching circuit such that the output voltage level of the DC output voltage emulates a discharge voltage curve of a dry battery while the rechargeable battery is being discharged.

### BACKGROUND

Lithium batteries have a discharge voltage curve that has a DC output voltage level that remains relatively constant from fully capacity to full discharge. Once the lithium battery reaches full discharge, the DC output voltage level drop precipitously to near zero volts. While the discharge voltage curve of a lithium battery is advantageous since it is more power efficient is some circumstances, not all electrical equipment is designed to operate with the discharge voltage curve of a lithium battery. For example, some electrical equipment is designed to operate with dry batteries. Dry batteries have a discharge voltage curve where the DC output voltage level drops as the dry battery is discharged from full charge to a full discharge. In other words, the internal resistance of a dry battery increases from full charge to full discharge. In some circumstances, using a lithium battery to power electrical equipment designed for dry batteries damages the electrical equipment.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a converter 100, in accordance with some embodiments.

FIG. 2 is a circuit diagram of a converter 200, in accordance with some embodiments.

FIG. 3A-FIG. 3C are voltage and current graphs for three different types of dry batteries that are emulated by the converter 200 in FIG. 2, in accordance with some embodiments.

FIG. 4 is a flow diagram 400 that illustrates a method of converting a lithium battery voltage generated by a lithium battery, in accordance with some embodiments.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

a microcontroller unit (MCU) and a DC to DC converter. The DC to DC converter is configured to generate pulse width modulated (PWM) voltage from the rechargeable battery voltage and then convert the PWM voltage into a DC output voltage. The output voltage level of the DC output voltage is set by the duty cycle of the PWM voltage. The MCU adjusts the duty cycle of the PWM voltage to adjust the output voltage level of the DC output voltage. The MCU is configured to adjust the output voltage level of the DC output voltage so that the output voltage level emulates a discharge voltage curve of a dry battery as the rechargeable battery is being discharged.

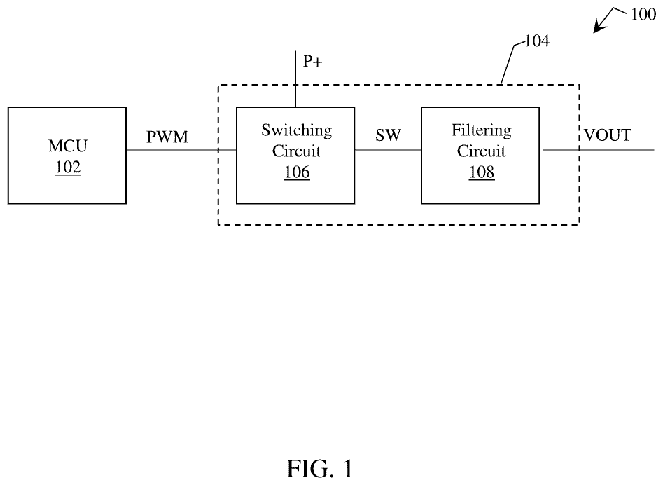

FIG. 1 is a block diagram of a converter 100, in accordance with some embodiments.

The converter 100 includes a microcontroller unit (MCU) 102 and a DC to DC converter 104. The converter 100 is configured to receive a rechargeable battery voltage P+ that is generated by a rechargeable battery (not explicitly show in FIG. 1). In some embodiments, the rechargeable battery is a lithium battery. The rechargeable battery voltage P+ is a direct current (DC) voltage. For example, lithium batteries generate the rechargeable battery voltage P+ so that the DC voltage level of the rechargeable battery voltage P+ is relatively constant while the lithium battery is being discharged from full power level (e.g., full charge) to a minimum power level (e.g., full discharge). However, once the lithium battery reaches the minimum power level, the DC voltage level of the lithium battery voltage P+ drops off sharply. While the rechargeable battery discharge voltage curve of a lithium battery is advantageous is many respects, the lithium battery discharge voltage profile can damage electrical equipment designed for dry batteries (e.g., alkaline batteries, carbon batteries, etc.).

The converter 100 is configured to convert the rechargeable battery voltage P+ into a DC output voltage VOUT having an output voltage level that emulates the discharge voltage curve of a dry battery while the rechargeable battery is being discharged. In some embodiments, the discharge voltage curve of the dry battery being emulated is the discharge voltage curve of an alkaline battery. In some embodiments, the discharge voltage curve of the dry battery being emulated is the discharge voltage curve of a carbon battery. In some embodiments, the discharge voltage curve of the dry battery being emulated is the discharge voltage curve of a dry battery other than an alkaline battery or a dry battery. In some embodiments, the discharge voltage curve of the dry battery being emulated is the discharge voltage curve of an 18650 battery.

The DC to DC converter 104 is configured to convert the rechargeable battery voltage P+ into the DC output voltage VOUT. The MCU 102 is configured to control the DC to DC converter 104 such that the output voltage level of the DC output voltage VOUT emulates the discharge voltage curve of the dry battery. The DC to DC converter 104 includes a switching circuit 106 and a filtering circuit 108. The switching circuit 106 is configured to generate a pulse width modulated (PWM) voltage SW from the rechargeable battery voltage P+. The filtering circuit 108 is configured to filter high frequency components out of the PWM voltage SW so as to generate the output voltage VOUT from the PWM voltage SW.

In FIG. 1, the MCU 102 is configured to generate a control signal PWM that is received by the DC to DC converter 104. In this embodiment, the control signal PWM is received by the switching circuit 106. The switching circuit 106 is configured to set a variable duty cycle of the PWM signal SW. With the control signal PWM, the MCU 102 adjusts the variable duty cycle of the PWM voltage PW such that the output voltage level of the DC output voltage VOUT emulates a discharge voltage curve of a dry battery while the rechargeable battery is being discharged.

In some embodiments, a double A (“AA”) alkaline battery is emulated. In some embodiments, a alkaline AA is discharged at different current levels (like 100 mA, 200 mA, 300 mA, 400 mA, 500 mA, 750 mA, 1000 mA, 1200 mA, 1500 mA, 2000 mA, 2500 mA, 3000 mA, etc. . . . ) at a voltage level of 0.9V. In this manner, data for a discharge voltage curve is obtained. In some embodiments USB-ported AA size lithium batteries are discharged with the same discharge currents as listed above to obtain discharge voltage curves for the lithium batteries. Once the discharge voltage curves for the alkaline batteries and the lithium batteries are obtained. Logic and/or programs for the MCU 102 is determined that converts the discharge voltage curve of the lithium batter(ies) to the discharge voltage curve of the alkaline batter(ies).

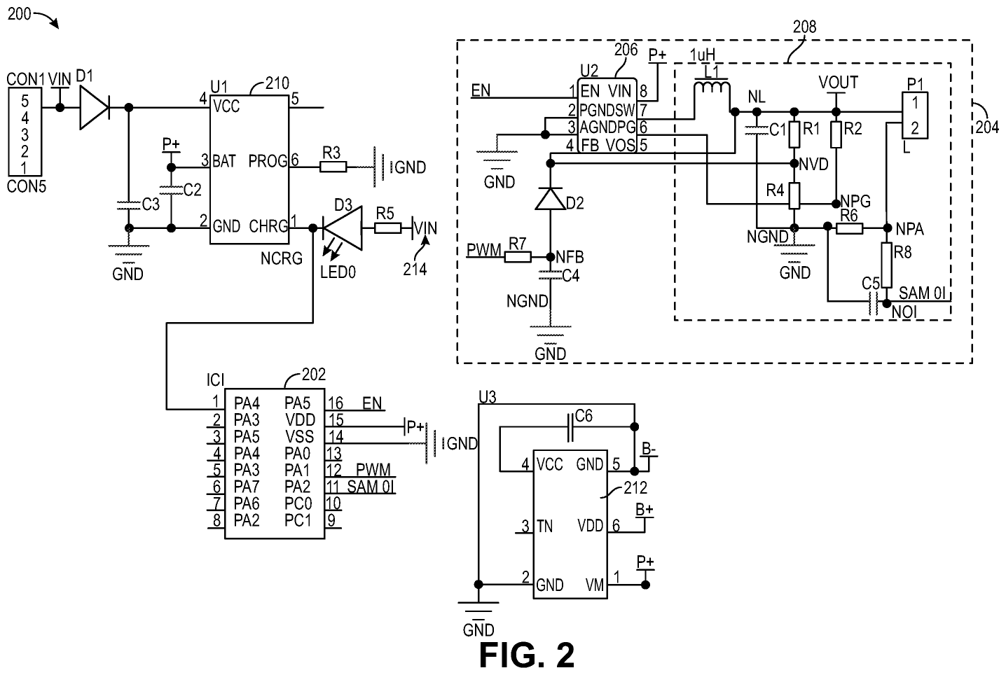

FIG. 2 is a circuit diagram of a converter 200, in accordance with some embodiments.

The converter 200 in FIG. 2 corresponds to the converter 100 in FIG. 1, in accordance with some embodiments.

The converter 200 includes an MCU 202 that corresponds to the MCU 102 in FIG. 1, in accordance with some embodiments. The converter 200 includes a DC to DC converter 204 that corresponds to the DC to DC converter 104 in FIG. 1, in accordance with some embodiments. The DC to DC converter 204 includes a switching circuit 206 that corresponds to the switching circuit 106 in FIG. 1, in accordance with some embodiments. The DC to DC converter 204 includes a filtering circuit 208 that corresponds to the filtering circuit 108 in FIG. 1, in accordance with some embodiments. Additionally, the DC to DC converter 204 includes a charge discharge control unit 210 and a protection circuit 212.

In FIG. 2, the MCU 202 includes MCU terminals 1-16. The control signal PWM is generated from MCU terminal 12 of the MCU 202. The MCU 202 is configured to receive a feedback signal SAM OI from the filtering circuit 208 at MCU terminal 11. The MCU 202 is configured to receive a ground voltage GND (which corresponds to the lower rail voltage VSS in this embodiment) at MCU terminal 14. The MCU 202 is configured to receive an enable signal IC1 at MCU terminal 1. The MCU 202 is configured to generate an enable signal EN at MCU terminal 16. In this embodiment, the MCU 202 is an integrated circuit (IC). In some embodiments, the MCU 202 has 8, 16, 24, 32, or 64 pins. However, the MCU 202 may have any number of pins.

The switching circuit 206 includes switching circuit terminals 1-16. The switching circuit terminal 1 is configured to receive the enable signal EN from the MCU terminal 16 of the MCU. Switching circuit terminal 2 corresponds to power ground PGND and switching circuit terminal 3 corresponds to an analog ground AGND. Switching circuit terminal 2 and switching circuit terminal 3 are connected to receive the ground voltage GND. Switching circuit terminal 4 is configured to receive a feedback signal FB from the filtering circuit 208. Switching circuit terminal 5 is configured to receive a voltage output sense signal VOS from the filtering circuit 208. Switching circuit terminal 6 is configured to receive a power good signal PG from the filtering circuit 208. Switching circuit terminal 7 is configured to output the PWM voltage SW. Switching circuit terminal 8 is configured to receive the rechargeable battery voltage P+ from the rechargeable battery.

The switching circuit 206 and filtering circuit 208 are configured so that the DC to DC converter 204 shown in FIG. 2 is a step down DC to DC converter (e.g., a buck converter). In other embodiments, the DC to DC converter 204 is configured as a boost converter. In still other embodiments, the DC to DC converter 204 is configured as a buck boost converter. With regards to the filtering circuit 208 shown in FIG. 2, an inductor L1 is connected between switching circuit terminal 7 and a node NL. In FIG. 2, the inductor L1 has an inductance of 1 μH. In other embodiments, the inductor L1 has an inductance between 1 μH-2.2 μH.

The DC output voltage VOUT is output from node NL. The voltage output sense signal VOS is received at switching circuit terminal 5 from the node NL. A resistor R1 is connected between the node NL and a node NVD. In some embodiments, the resistor R1 has a resistance of 233 Kohm. In other embodiments, the resistor R4 has a different value but a change in the value of the resistor R4 would result in changes to the values in the other components in the filtering circuit 208.

A resistor R4 is connected between the node NVD and the ground node NGND. In some embodiments, the resistor R4 has a resistance of 100 Kohm. In other embodiments, the resistor R4 has a different value but a change in the value of the resistor R4 would result in changes to the values in the other components in the filtering circuit 208.

The feedback signal FB is received from the terminal NVD at switching circuit terminal 4. A resistor R2 is connected between the node NL and node NPG. In some embodiments, the resistor R2 has a resistance of 400-500 Kohm. In other embodiments, the resistor R2 has a different value but a change in the value of the resistor R2 would result in changes to the values in the other components in the filtering circuit 208.

The power good signal PG is received at the switching circuit terminal 6 from the node NPG. A terminal point P1 is connected between node NL and a node NPA. A capacitor C1 is connected between the node NL and the ground node NGND. In some embodiments, the capacitor C1 has a capacitive value of between 106-226 μF. The capacitor C1 performs filtering and helps control self-discharge. The ground node NGND is configured to receive the ground voltage GND. A resistor R6 is connected is connected between the node NPA and the ground node NGND. A resistor R5 is connected between the node NPA and a node NPA. The resistor R5 controls the brightness of charging indicators. In some embodiments, the resistor R5 has a resistance of 7.7 to 10 Kohm. In other embodiments, the resistor R2 has a different value but a change in the value of the resistor R2 would result in changes to the values in the other components in the filtering circuit 208.

A capacitor C5 is connected between the node NOI and the ground node NGND. The feedback signal SAM OI is received at the MCU terminal 11 from the node NOI.

The feedback signal level of the feedback signal SAM OI is indicative of the output voltage level of the DC output voltage VOUT. The feedback signal level of the feedback signal FB is also indicative of the output voltage level of the DC output voltage VOUT. The switching circuit 206 is configured to control switching the PWM voltage on and switching the PWM voltage off in accordance with a feedback signal level of a feedback signal FB from the filtering circuit 208. In some embodiments, the switching circuit includes an error amplifier wherein the feedback signal FB is a high-impedance input to the error amplifier. The error amplifier compares an internal reference voltage, VREF to the feedback signal FB. Resistors R1, R4 is a voltage divider provides a set point for the output voltage. In response to the difference between feedback voltage level of the feedback signal FB and the reference voltage VREF reaches a set value, the switching circuit 206 turns off the PWM voltage SW. In response to the difference between feedback voltage level of the feedback signal FB and the reference voltage VREF being greater than a set value, the switching circuit 206 turns on the PWM voltage SW. Thus, the switching circuit 206 is configured to control switching the PWM voltage SW on and switching the PWM voltage SW off in accordance with the feedback signal level of the feedback signal FB from the filtering circuit 208. As such, the switching circuit 206 sets the duty cycle of the PWM voltage

In FIG. 2, the MCU 202 is configured to generate the PWM control signal PWM that is applied to the feedback signal FB to adjust the feedback signal level such that the DC output voltage VOUT emulates the discharge voltage curve of the dry battery while the rechargeable battery is being discharged. By applying the PWM control signal PWM to the feedback signal FB, the difference between feedback voltage level of the feedback signal FB and the reference voltage VREF in the switching circuit 206 is adjusted thereby allowing the MCU 202 to control the duty cycle of the switching signal. In this manner, the MCU 202 controls the output voltage level of the DC output voltage VOUT such that the output voltage level emulates the discharge voltage curve of the dry battery. The feedback signal SAM OI is input into the MCU 202 so that the output voltage level is adjusted to a target DC voltage level that is set in accordance with the emulated discharge output voltage curve.

To apply the PWM control signal PWM, the PWM control signal is applied through a resistor R7. In some embodiments, the resistor R7 has a resistance value of 10-20 Kohm. The resistor R7 is an integrating resistor that words with a capacitor C4. In other embodiments, the resistor R7 has a different value but a change in the value of the resistor R7 would result in changes to the values in the other components in the filtering circuit 208.

The resistor R7 is connected between MCU terminal 12 and a node NFB. The capacitor C4 is connected between the node NFB and the ground node NGND. The capacitance C4 is 10 cubed p-10 to the 4^{th} power p. The capacitor C4 is charged by the PWM control signal PWM. A diode D2 is connected between the node NFB and the node NVB. The node NVB is connected to switching circuit terminal 4, which receives the feedback signal FB. Thus, the voltage generated by charging the capacitor C4 is applied at the node NVD to thereby raise or lower the voltage of the feedback signal FB. In this manner, the PWM control signal PWM adjust the feedback signal FB, which thereby adjust the duty cycle of the switching signal SW.

The MCU 202 is configured to enable the switching circuit 206. The switching circuit 206 is configured to be enabled in response to the enable signal EN being in a first state and to be disabled in response to the enable signal EN being in a second state. The charge discharge control unit 210 is configured to detect when the rechargeable battery is being discharged and enable the MCU 202 in response to detecting that the rechargeable battery is being discharged. The MCU 202 is configured to enable the switching circuit 206 in response to being enabled thereby providing the enable signal EN in the first state.

The charge discharge control unit 210 performs undervoltage/overvoltage/overcurrent detection and protection control on the rechargeable battery. The charge discharge control unit 210 detects whether the load is connected at management unit terminal 4. The charge discharge control unit 210 is configured to generate an enable signal IC1 from management unit terminal 4, which is applied at node NCRG. Both the management unit terminal 4 and the MCU terminal 1 are connected to the node NCRG. If the load is not connected, the charge discharge control unit 210 generates the enable signal IC1 in a disable state. In response, the MCU 202 generates the enable signal EN so that the switching circuit 206 is disabled. However, if the load is connected, the charge discharge control unit 210 generates the enable signal IC1 in an enabling state. Accordingly, the MCU 202 generates the enable signal EN so that the switching circuit 206 is enabled.

The MCU 202 controls the change of the duty cycle by calculating the capacity of the rechargeable battery to simulate the dry battery. In some embodiments, the charge discharge control unit 210 is a 4054 or 4057 linear charging IC. In some embodiments, the charge discharge control unit 210 presets a current limit value during charging of the rechargeable battery. In one embodiment, the current limit value to charge the rechargeable battery is 300 mA. When the rechargeable battery is in the charging state, the charge discharge control unit 210 controls a light emitting diode (LED) D3 so that a red light is lit up. A resistor R5 is connected between an input terminal 214 and an anode of the LED D3. A cathode of the LED D3 is connected to the node NCRG. When the rechargeable battery is fully charged or saturated, the LED D3 emits a green light. When the load is not connected, the charge discharge control unit 210 enters the low power mode and detects whether the load is connected at regular time intervals.

The protection circuit 212 is configured to protect the rechargeable battery during charging and discharging to prevent damage to the battery caused by overload or overcharge.

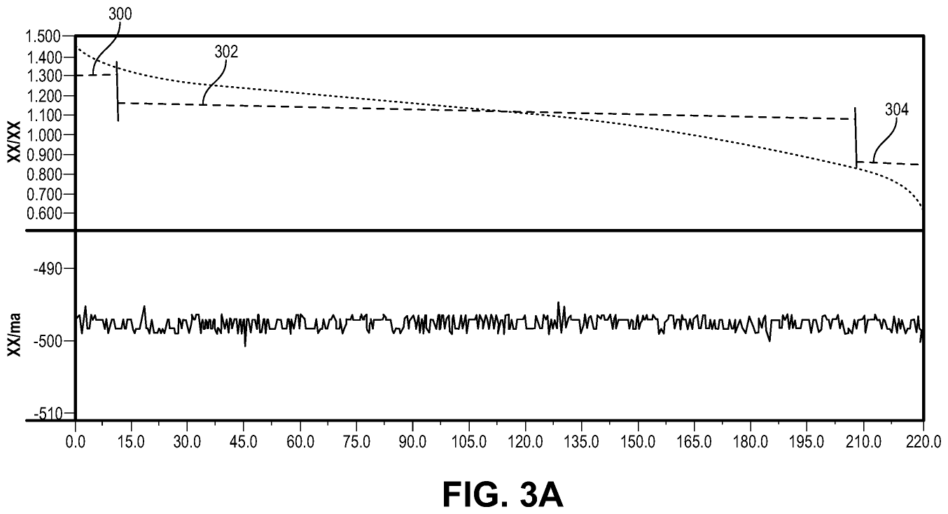

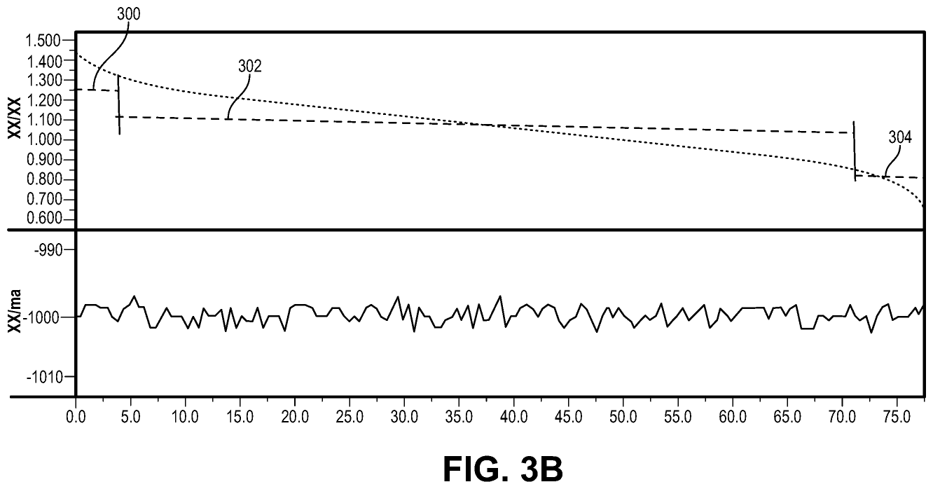

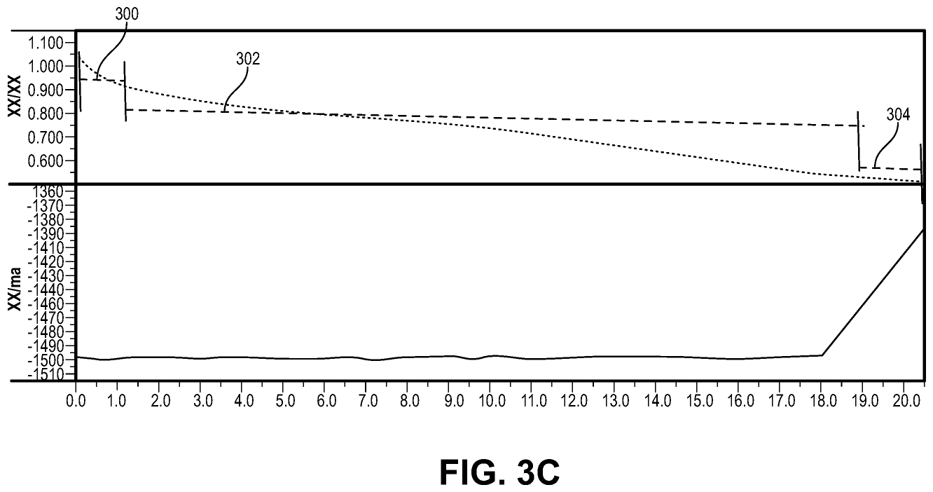

FIG. 3A-FIG. 3C are voltage and current graphs for three different types of dry batteries that are emulated by the converter 200 in FIG. 2, in accordance with some embodiments.

FIG. 3A, FIG. 3B, and FIG. 3C has time in the horizontal axis. In this example, the unit of time is in minutes. The top portion of FIG. 3A, FIG. 3B, and FIG. 3C illustrate a discharge voltage curve of the output voltage VOUT as the rechargeable battery is being discharged. Accordingly, an output voltage level of the output voltage VOUT is shown in the horizontal axis of the top portion of FIG. 3A, FIG. 3B, and FIG. 3C. As shown, the voltage level continuously decreases over time as the respective battery is discharged. As shown in the top portions of FIG. 3A, 3B, 3C, a beginning section 300 of the curve decreases the output voltage level with increasing speed (e.g., first derivative) but decreasing acceleration (e.g., second derivative). A middle section 302 of the curve decreases the output voltage level with a constant speed (e.g., first derivative) but no acceleration (e.g., second derivative). The middle section 302 is thus linear. A final section 304 of the curve decreases the output voltage level with increasing speed (e.g., first derivative) but increasing acceleration (e.g., second derivative). The discharge voltage curve thus approximates an S-curve.

The bottom portion of FIG. 3A, FIG. 3B, and FIG. 3C illustrate a current level of 3 different constant discharge currents (FIG. 3A is 500 mA, FIG. 3B is 1000 mA, FIG. 3C is 1500 mA). As shown by FIG. 3A, FIG. 3B, and FIG. 3C higher current levels will have shorter voltage curves while lower current levels will have long voltage curve, in accordance with some embodiments.

The different discharge current curves and discharge voltage curves are used to design the MCU 202.

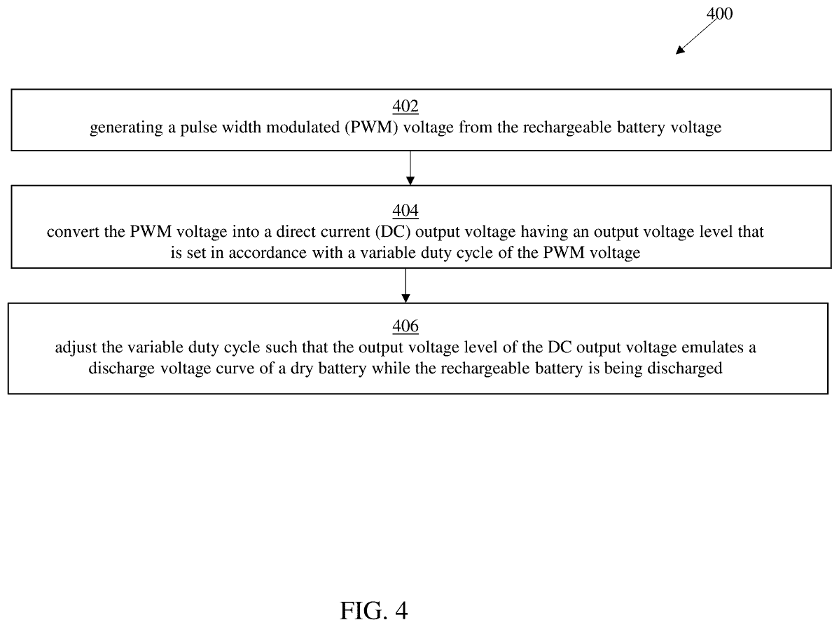

FIG. 4 is a flow diagram 400 that illustrates a method of converting a rechargeable battery voltage generated by a rechargeable battery, in accordance with some embodiments.

Flow diagram 400 includes blocks 402-406. In some embodiments, blocks 402-406 are performed by the converter 100 in FIG. 1 or the converter 200 in FIG. 2. Flow begins at block 402.

At block 402, a pulse width modulated (PWM) voltage from the rechargeable battery voltage is generated. In some embodiments, the PWM voltage is the PWM voltage SW in FIG. 1 and FIG. 2. In some embodiments, the PWM voltage is generated by the switching circuit 106 in FIG. 1 or the switching circuit 206 in FIG. 2. Flow then proceeds to block 404.

At block 404, the PWM voltage is converted into a direct current (DC) output voltage having an output voltage level that is set in accordance with a variable duty cycle of the PWM voltage. In some embodiments, the DC output voltage is the DC output voltage VOUT in FIG. 1 and FIG. 2. In some embodiments, the filtering circuit 108 in FIG. 1 or the filtering circuit 208 in FIG. 2 converts the PWM voltage in to the DC output voltage. Flow then proceeds to block 406.

At block 406, the variable duty cycle is adjusted such that the output voltage level of the DC output voltage emulates a discharge voltage curve of a dry battery while the rechargeable battery is being discharged. In some embodiments, the variable duty cycle is adjusted by the MCU 102 in FIG. 1 or the MCU 202 in FIG. 2

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A converter for a rechargeable battery configured to generate a rechargeable battery voltage, the converter comprising:
a direct current (DC) to DC converter that includes:
a switching circuit configured to generate a pulse width modulated (PWM) voltage from the rechargeable battery voltage, wherein the switching circuit is configured to set a variable duty cycle of the PWM voltage;
a filtering circuit configured to convert the PWM voltage into a DC output voltage having an output voltage level that is set in accordance with the variable duty cycle of the PWM voltage;
a microcontroller unit (MCU) configured to adjust the variable duty cycle of the switching circuit such that the output voltage level of the DC output voltage emulates a discharge voltage curve of a dry battery while the rechargeable battery is being discharged.

2. The converter of claim 1, wherein the discharge voltage curve of the dry battery is a discharge voltage curve of an alkaline battery or a carbon battery.

3. The converter of claim 1, wherein:
the switching circuit is configured to control switching the PWM voltage on and switching the PWM voltage off in accordance with a feedback signal level of a feedback signal from the filtering circuit;
the MCU is configured to generate a PWM control signal that is applied to the feedback signal to adjust the feedback signal level such that the DC output voltage emulates a discharge voltage curve of the dry battery while the rechargeable battery is being discharged.

4. The converter of claim 1, wherein the MCU is configured to enable the switching circuit.

5. The converter of claim 4, further comprising:
a charge discharge control unit configured to detect when the rechargeable battery is being discharged and enable the MCU in response to detecting that the rechargeable battery is being discharged, wherein the MCU is configured to enable the switching circuit in response to being enabled.

6. The converter of claim 5, wherein the charge discharge control unit is configured to disable the rechargeable battery from discharging in response to a rechargeable battery discharge current having a current level that is above a threshold current limit.

7. The converter of claim 5, wherein the charge discharge control unit is configured to detect when a load is connected to receive the DC output voltage from the filtering circuit.

8. The converter of claim 1, wherein the switching circuit and the filtering circuit are configured such that the DC to DC converter is a step down DC to DC converter.

9. The converter of claim 1, wherein the rechargeable battery is a lithium battery.

10. A method of converting a rechargeable battery voltage generated by a rechargeable battery, comprising:
generating a pulse width modulated (PWM) voltage from the rechargeable battery voltage;
converting the PWM voltage into a direct current (DC) output voltage having an output voltage level that is set in accordance with a variable duty cycle of the PWM voltage; and
adjusting the variable duty cycle such that the output voltage level of the DC output voltage emulates a discharge voltage curve of a dry battery while the rechargeable battery is being discharged.

11. The method of claim 10, wherein the discharge voltage curve of the dry battery is a discharge voltage curve of an alkaline battery or a carbon battery.

12. The method of claim 10, further comprising:
controlling switching the PWM voltage on and switching the PWM voltage off in accordance with a feedback signal level of a feedback signal from the filtering circuit;
generating a PWM control signal that is applied to the feedback signal to adjust the feedback signal level such that the DC output voltage emulates a discharge voltage curve of the dry battery while the rechargeable battery is being discharged.

13. The method of claim 10, further comprising enabling a switching circuit that switches the PWM voltage on and the PWM voltage off.

14. The method of claim 13, further comprising:
detecting when the rechargeable battery is being discharged; and
enabling an microcontroller unit (MCU) in response to detecting that the rechargeable battery is being discharged, wherein the MCU is configured to enable the switching circuit in response to being enabled.

15. The method of claim 14, further comprising:
disabling the rechargeable battery from discharging in response to a rechargeable battery discharge current having a current level that is above a threshold current limit.

16. The method of claim 14, further comprising detecting when a load is connected to receive the DC output voltage.

17. The method of claim 10, wherein:
generating the PWM voltage from the rechargeable battery voltage with a switching circuit;
generating the DC output voltage from the PWM voltage with a filtering circuit.

18. The method of claim 17, wherein the switching circuit and the filtering circuit are configured as a step down DC to DC converter.

19. The method of claim 10, wherein the rechargeable battery is a lithium battery.

20. An apparatus, comprising:
a rechargeable battery configured to generate a rechargeable battery voltage;
a converter configured to convert the rechargeable battery voltage into a DC output voltage having an adjustable output voltage level;
a controller configured to adjust the adjustable output voltage level of the DC output voltage such that the adjustable output voltage level emulates a discharge voltage curve of a dry battery while the rechargeable battery is being discharged.
